(19) United States
(12) Patent Application Publication
(10) Pub. No.: US 2010/0158649 A1
(43) Pub. Date: Jun. 24, 2010

(54) Silo with reciprocating frame having composite blade

(75) Inventors: Franz Tillman, Lagrangeville, NY (US); Charles Wanstrom, Maplewood, MN (US); Thomas M. Anderson, Naples, FL (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Schwing Bioset, Inc., Somerset, WI (US)

(21) Appl. No.: 12/317,400

(22) Filed: Dec. 23, 2008

(51) Int. Cl. B65G 65/00; B29C 47/00

(52) U.S. Cl. 414/306; 156/245

(57) ABSTRACT

A reciprocating frame for a silo has a rim and at least one support extending across an interior of the rim. A first composite blade is located on the rim and includes a filler material. A method of manufacturing a composite blade for a reciprocating frame includes forming an angle base to define a pocket, filling the pocket with a filler material, and forming the angle base and filler material into a composite beveled cutting surface for reciprocating frame.

### BACKGROUND

The present invention relates generally to a method and a device for discharging material from a silo. More specifically, the present invention relates to a silo having a reciprocating frame.

Silos are large receptacles used to store and discharge materials. Silos usually have an inlet at the top and an outlet at the bottom. Virtually any type of material may be placed into a silo and later discharged. Viscous wet materials, however, are difficult to discharge because they are not free-flowing. For example, municipal waste sludge stored in silos tends to clump together and form bridges over a discharge opening. Discharge devices may be incorporated into the bottom of a silo above a discharge opening to dislodge material bridges and induce sludge flow.

Several types of discharge devices for coaxing sludge out of silos are known. In rectangular and square silos, the push floor design is common. The push floor consists of a series of hydraulically driven ladders that move linearly to convey sludge toward a discharge opening. In circular or polygonal silos, rotating scrapers or movable frames may be incorporated near the silo floor. In the case of rotating scrapers, radial arms extending from a central body include rotating or oscillating scrapers that break up clumps of sludge. In the case of movable frames, an open frame structure reciprocates back and forth over the silo floor pushing and pulling sludge along with it and over a discharge opening. While inclusion of a discharge device near the floor of a silo is known, the construction and operation of such discharge devices are far from ideal.

### SUMMARY

An exemplary embodiment of the present invention is a reciprocating frame for a silo. The reciprocating frame includes a rim and at least one support extending across an interior of the rim. A first composite blade is located on the rim and includes a filler material. The first composite blade forms a first beveled cutting surface for a reciprocating frame.

Another exemplary embodiment of the present invention is a method of manufacturing a composite blade for a reciprocating frame. The method includes forming an angle base to define a pocket, filling the pocket with a filler material, and machining the angle base and the filler material into a composite beveled cutting surface for a reciprocating frame.

### BRIEF DESCRIPTION OF THE DRAWINGS

FIG. 1 is a perspective view of a silo containing a reciprocating frame.

FIG. 2 is a top view of the inside of the silo from FIG. 1 with the reciprocating frame in a first, fully retracted position.

FIG. 3 is a top view of the inside of the silo with the reciprocating frame in a second, fully extended position.

FIG. 4 is a detailed top view of the reciprocating frame.

FIG. 5A is a side elevation and FIG. 5B is a front elevation of the reciprocating frame from FIG. 4.

FIG. 6 is a cross-section of a blade constructed from a single metal angle plate forming an angle base.

FIG. 7 is a cross-section of a blade constructed from a metal plate bent to form an angle base.

FIG. 8 is a cross-section of a blade constructed from two flat metal pieces welded together to form an angle base.

FIG. 9 is a diagram of a method of manufacturing a blade for a reciprocating frame.

### DETAILED DESCRIPTION

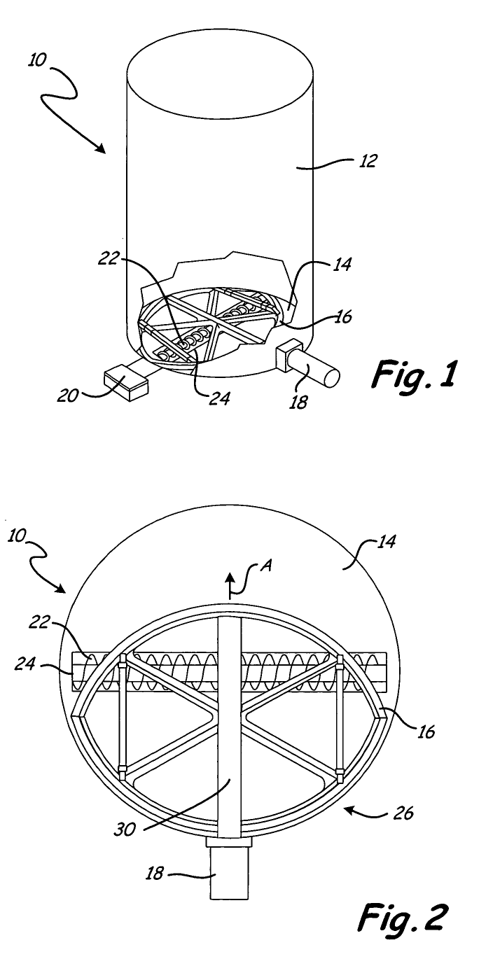

FIG. 1 is a perspective view of silo 10 with a portion of perimeter wall 12 broken away to expose floor 14 and reciprocating frame 16. Also visible are hydraulic system 18, outlet 20, screw conveyor 22, and opening 24.

Silo 10 includes perimeter wall 12 attached to floor 14. Perimeter wall 12 is an upstanding cylinder resting on top of circular floor 14. Reciprocating frame 16 is located within silo 10 immediately above and parallel to floor 14. Reciprocating frame 16 is an open structure attached to hydraulic system 18, which extends beyond perimeter wall 12. Outlet 20 is also exterior to perimeter wall 12. Outlet 20 is connected to screw conveyor 22, which is beneath opening 24 in floor 14. Opening 24 is an elongated rectangle that extends substantially across a diameter of circular floor 14.

Material is generally stored within silo 10 to be discharged at a later time. Usually, material is placed into silo 10 through an opening in a top of silo 10, although other configurations are known. Gravity causes material placed in silo 10 to accumulate near floor 14. All sorts of materials may be stored in silo 10, including dry materials, wet materials, or sludge-like combinations of wet and dry materials. When the material is highly viscous, it tends to resist natural gravitational flow. In at least this instance, it is desirable to include reciprocating frame 16 near floor 14 to mechanically induce flow in the viscous material. Reciprocating frame 16 is attached to hydraulic system 18, which actuates reciprocating frame 16 across floor 14. The resulting back and forth movement of reciprocating frame 16 breaks up cohesive masses while pushing and pulling the material toward opening 24. Beneath opening 24 in floor 14 is at least one screw conveyor 22. Material falls through opening 24 and onto screw conveyor 22, which may include a rotating screw and/or a means for metering material. Screw conveyor 22 then discharges material from silo 10 via outlet 20. Discharged material may be picked up and transported to another location.

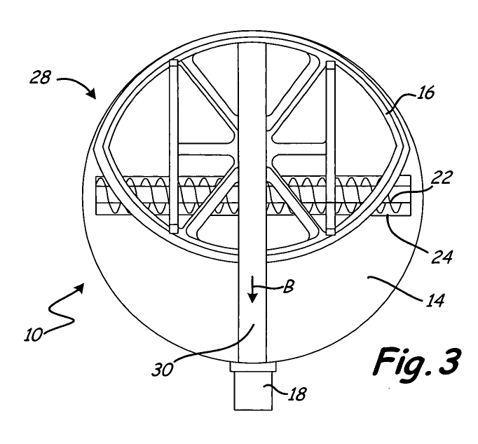

FIGS. 2 and 3 depict the movement of reciprocating frame 16 across floor 14. FIG. 2 is a top view of the inside of silo 10 with reciprocating frame 16 in first, fully retracted position 26. FIG. 3 is a top view of the inside of silo 10 with reciprocating frame 16 in second, fully extended position 28. Also visible in FIGS. 2 and 3 are hydraulic system 18, screw conveyor 22, opening 24, and pushrod 30.

Reciprocating frame 16 is connected to hydraulic system 18 via pushrod 30. At rest, reciprocating frame 16 is in first, fully retracted position 26 as depicted in FIG. 2. Once activated, hydraulic system 18 drives pushrod 30 further into silo 10, which actuates reciprocating frame 16 across floor 14 in direction A. Reciprocating frame 16 leaves first position 26 pushing and pulling material toward opening 24, encouraging material to fall through opening 24 onto screw conveyor 22. Reciprocating frame 16 will continue across floor 14 in direction A until pushrod 30 reaches full extension, or until an obstruction prevents further movement.

If no obstruction is encountered and hydraulic system 18 remains activated, reciprocating frame 16 will reach second, fully extended position 28 on an opposite end of silo 10, which is depicted in FIG. 3. Reciprocating frame 16 will move across floor 14 once between occupying first position 26 and occupying second position 28. In second position 28, reciprocating frame 16 is remote from hydraulic system 18 and pushrod 30 is fully extended. Pushrod, 30 is capable of retracting back toward hydraulic system 18 and actuating reciprocating frame 16 back across floor 14 in direction B. Reciprocating frame 16 leaves second position 28 pushing and pulling material toward opening 24, once again encouraging material to fall through opening 24 onto screw conveyor 22. If no obstruction is encountered and hydraulic system 18 remains activated, pushrod 30 will retract until reciprocating frame 16 has returned to first position 26. The resulting movement of reciprocating frame 16 between first position 26 and second position 28 agitates viscous material and coaxes material to fall through opening 24 onto screw conveyor 22 for discharge from silo 10.

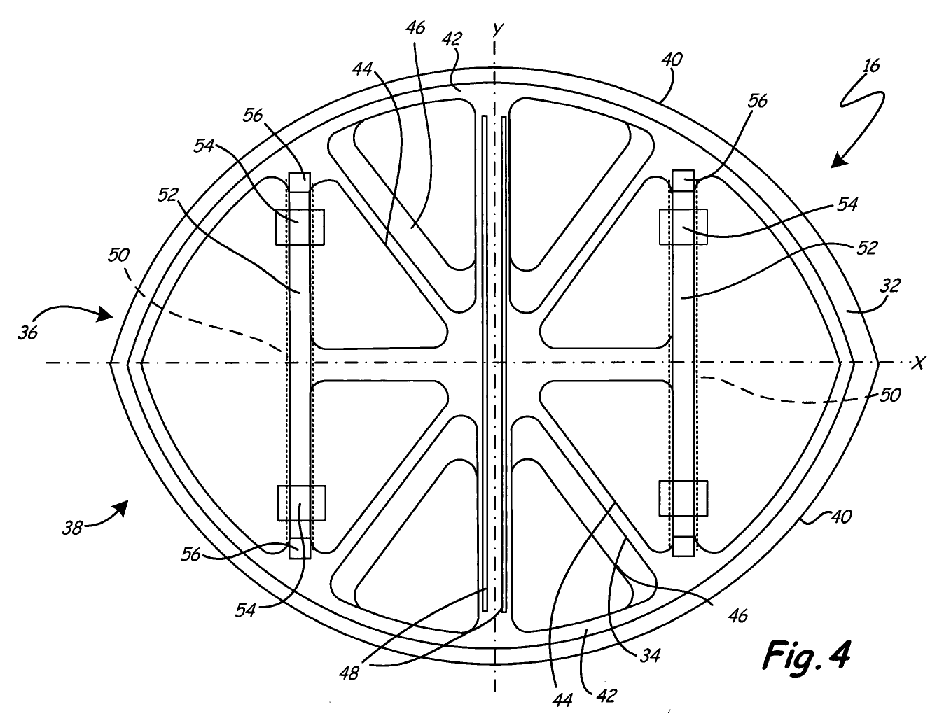

FIG. 4 is detailed top view of reciprocating frame 16 including rim 32 and center scraper 34. Rim 32 has first half 36, second half 38, outer surface 40, and inner surface 42. Center scraper 34 has outer surface 44 and inner surface 46. Also visible are bars 48, supports 50, tubes 52, hold-down plates 54, and tube ends 56.

Reciprocating frame 16 has rim 32 which extends around and contains center scraper 34. In one embodiment, rim 32 is shaped like an ellipse or football, and center scraper 34 is shaped like the letter “X” which extends across a minor axis, of rim 32. The shape of rim 32 and center scraper 34 is dependant on a multitude of factors including the diameter of a silo, the location of an opening in the floor, and the type of materials to be stored in a silo. Rim 32 and center scraper 34 are capable of assuming alternate shapes while achieving the objectives outlined below.

Rim 32 has outer rim surface 40 facing outwardly, and inner rim surface 42 facing inwardly toward center scraper 34. Center scraper 34 extends across a y-axis of rim 32 so that a top part of center scraper 34 is attached to inner rim surface 42 of first half 36 of rim 32, and a bottom part of center scraper 34 is attached to inner rim surface 42 of second half 38 of rim 32. Center scraper 34 has inner scraper surface 44 facing inwardly toward the x-axis, and outer scraper surface 46 facing outwardly toward the y-axis. At least outer rim surface 40 and outer scraper surface 46 are beveled to reduce friction between reciprocating frame 16 and material within a silo. In one embodiment, the bevels on outer rim surface 40 and outer scraper surface 46 form approximately equal angles of approximately 15 degrees, although any acute angle is within the scope of the present invention. In an alternative embodiment, outer rim surface 40 forms an angle of 45 degrees from horizontal. The bevels of outer rim surface 40 and outer scraper surface 46 may be machined from a metal, such as carbon steel, or the bevels may include filler material in order to reduce manufacturing cost and/or friction between the bevels and material within a silo.

Bars 48 extend substantially across a y-axis of rim 32 and are centrally located within both rim 32 and center scraper 34. A first end of bars 48 extends toward first half 36 of rim 32. A second end of bars 48 extends toward second half 38 of rim 32. At least one support 50 is also located within rim 32. In FIG. 4, a plurality of supports 50 run parallel to bars 48 and extend substantially across the y-axis of rim 32, but are located on either side of center scraper 34. A first end of supports 50 extend toward first half 36 of rim 32, and a second end of supports 50 extend toward second half 38 of rim 32. Tubes 52 are located on top of, run the length of, and attach to, supports 50. In one embodiment, tubes 52 are rectangular and have closed, beveled tube ends 56. Tubes 52 may extend through, and be surrounded by, one or more hold-down plates 54. Each hold-down plate 54 is shaped like an upside down letter “U”, which is capable of surrounding a tube 52 and attaching to a floor of a silo to prevent the reciprocating frame from drifting upwards or over to one side of a silo.

As described above with reference to FIGS. 2 and 3, reciprocating frame 16 is capable of bi-directional movement across a floor of a silo. When reciprocating frame moves, it comes into contact with material and experiences resistance. At least outer rim surface 40 and outer scraper surface 46 are beveled to reduce friction between reciprocating frame 16 and material within a silo, although more surfaces may also be beveled (such as tube ends 56). The beveled surfaces slide under material as reciprocating frame 16 moves across a silo floor. Bars 48 are configured to attach reciprocating frame 16 to a pushrod of a hydraulic system. Supports 50 are configured to help maintain the shape of reciprocating frame 16, as well as support tubes 52. Tubes 52 are configured to cooperate with hold-down plates 54 to keep reciprocating frame 16 from floating upwards or over to one side. As reciprocating frame 16 moves from a first position to a second position, tubes 52 slide through one or more hold-down plates 54 thereby keeping reciprocating frame 16 adjacent a floor of a silo.

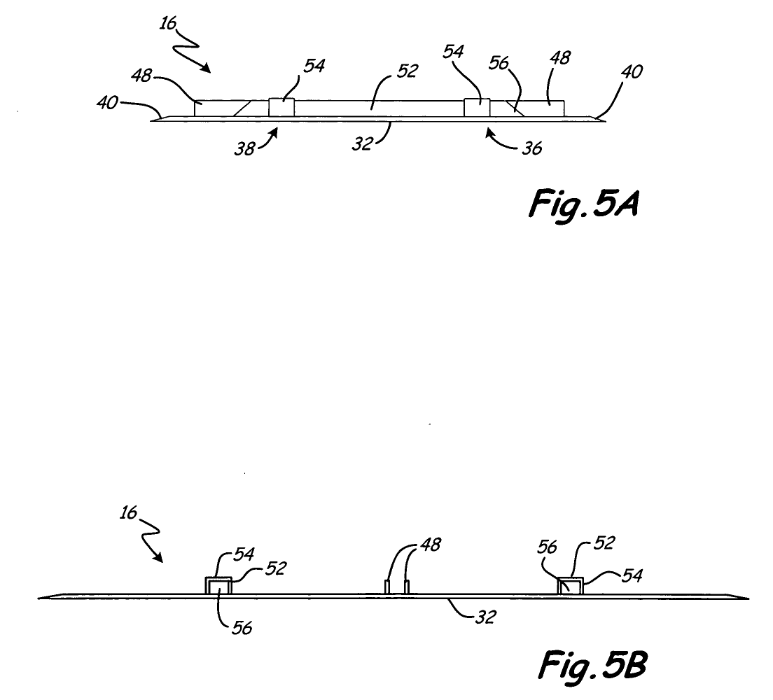

FIG. 5A is a side elevation and FIG. 5B is a front elevation of reciprocating frame 16 showing rim 32, first half 36, second half 38, outer rim surface 40, bars 48, tubes 52, hold-down plates 54, and tube ends 56. Rim 32 has first half 36, second half 38, and beveled outer rim surface 40. Bars 48 are centrally located within rim 32 and extend upwards to attach to a push-rod. Tubes 52 are located on either side of bars 48 and also extend upwards to cooperate with hold-down plates 54. Hold-down plates 54 extend around tubes 52 and attach to a silo floor beneath reciprocating frame 16 to hold the reciprocating frame 16 in place. In one embodiment, tube ends 56 are closed and beveled to reduce friction between tubes 52 and material within a silo.

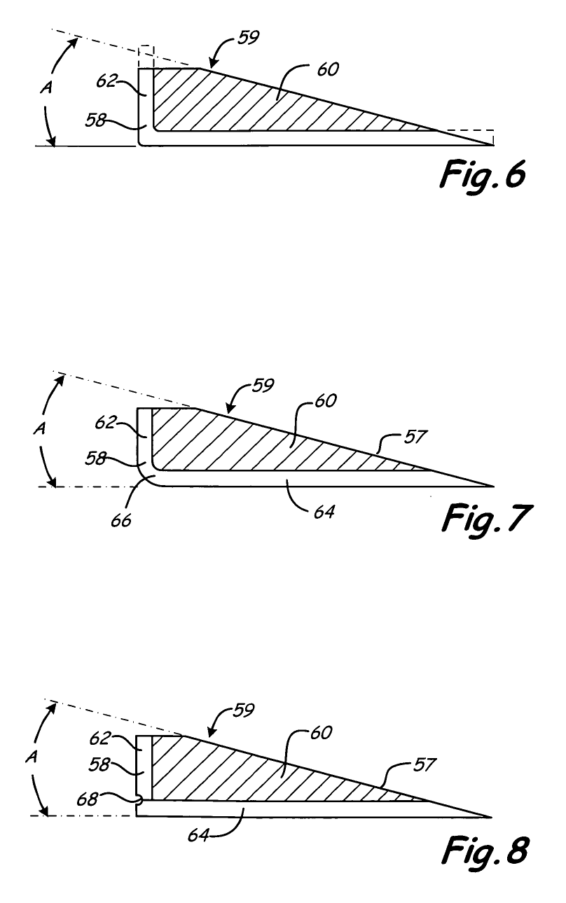

FIGS. 6-8 are cross-sections of composite blade 57 constructed from angle base 58 and filler material 60, which may machined produce a beveled cutting surface for a reciprocating frame. For example, composite blade 57 could be incorporated into outer rim surface 40 and/or outer scraper surface 46 to reduce friction between material within a silo and reciprocating frame 16 of FIG. 4. Composite blade 57 includes angle base 58 and filler material 60. Angle base 58 has vertical leg 62 and horizontal leg 64, which define pocket 59.

Angle base 58 may comprise a single angle plate (depicted in FIG. 6), a bent angle plate having bent portion 66 (depicted in FIG. 7), or two plates wherein vertical leg 62 is a first plate and horizontal leg 64 is a second plate (depicted in FIG. 8). Vertical leg 62 and horizontal leg 64 may be joined by weld 68 or any other suitable means of attachment. Angle base 58 may comprise metal, such as but not limited to, carbon steel. Regardless of the construction of angle base 58, vertical leg 62 and horizontal leg 64 define pocket 59 which is filled with filler material. A portion of vertical leg 62 and horizontal leg 64 may be machined and removed so that vertical leg 62 and horizontal leg 64 are flush with filler material 60. Filler material 60 may comprise any material that has a coefficient of friction lower than the coefficient of fiction of carbon steel. For example, filler material 60 may be Ultra High Molecular Weight Polyurethane.

Horizontal leg 64 and filler material 60 are machined to form composite blade 57 having angle A of approximately 15 degrees. It is appreciated that angle A may assume any acute angle and be within the scope of this invention. Composite blade 57 is intended to be incorporated into reciprocating frame 16 on at least outer rim surface 40 as a composite beveled cutting surface that reduces friction between reciprocating frame 16 and material within a silo. Producing composite blade 57 out of a combination of angle base 58 and filler material 60, instead of machined metal, lowers the coefficient of friction for composite blade 57 and lowers manufacturing costs of reciprocating frame 16

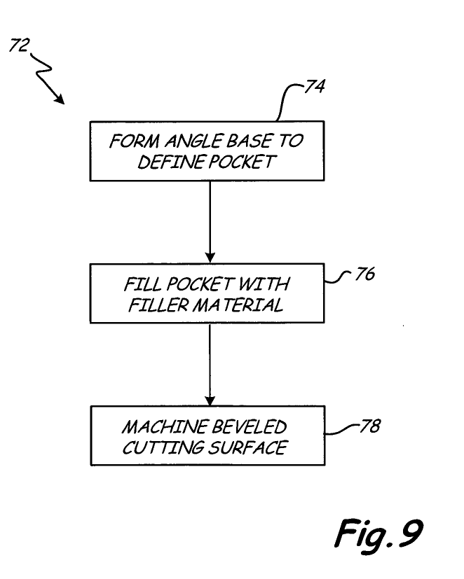

FIG. 9 is a diagram of method 72 for manufacturing a composite blade for a reciprocating frame. Method 72 includes forming an angle base to define a pocket 74, filling the pocket with a filler material 76, and machining the angle base and the filler material into a composite beveled cutting surface for a reciprocating frame 78. At least one piece of metal is used as the metal base to define a pocket 74. The angle base may be bent or welded in order to define pocket 74. The angle base may comprise, but is not limited to, carbon steel. Once pocket is formed, excess metal may machined off discarded and pocket is filled with filler material 76. The angle base and filler material is then machined into a composite beveled cutting surface for a reciprocating frame 78. It should be understood that steps 74, 76, and 78 need not be preformed in the aforementioned order. The angle base and filler material may be machined into a composite beveled cutting surface before or after being installed on the reciprocating frame. The combination of the angle base and the filler material may form a composite blade having an angle of approximately 15 degrees, although any acute angle is within the scope of this invention. In an alternative embodiment, the composite blade has an angle of approximately 45 degrees from horizontal. The filler material may be any material with a coefficient of friction equal to or lower than the coefficient of friction of steel. Method 72 provides a way to manufacture a composite blade for a reciprocating frame that has reduced coefficient of friction and lower manufacturing costs when compared to machined steel.

Although the present invention has been described with reference to preferred embodiments, workers skilled in the art will recognize that changes may be made in form and detail without departing from the spirit and scope of the invention.

1. A reciprocating frame for a silo, the reciprocating frame comprising:
a rim;
at least one support extending across an interior of the rim; and
a first composite blade located on the rim, the first composite blade including a filler material;
wherein the first composite blade forms a first beveled cutting surface for a reciprocating frame.

2. The reciprocating frame of claim 1, further comprising:
a second composite blade located on the support, the second composite blade including a filler material;
wherein the second composite blade forms a second beveled cutting surface for a reciprocating frame.

3. The reciprocating frame of claim 2, wherein the first composite blade is located on an outer surface of the rim and the second composite blade is located on an outer surface of the support.

4. The reciprocating frame of claim 1, wherein the first composite blade comprises an angle base having a horizontal leg and a vertical leg defining a pocket and the filler material fills the pocket, wherein the angle base and the filler material share the first beveled cutting surface for a reciprocating frame.

5. The reciprocating frame of claim 4, wherein the angle base comprises a metal angle plate.

6. The reciprocating frame of claim 4, wherein the angle base comprises a metal bent plate.

7. The reciprocating frame of claim 4, wherein the angle base comprises a first metal plate attached to a second metal plate.

8. The reciprocating frame of claim 7, wherein first metal plate is welded to the second metal plate.

9. The reciprocating frame of claim 4, wherein the angle base comprises carbon steel.

10. The reciprocating frame of claim 1, wherein the filler material has a coefficient of friction lower than carbon steel.

11. The reciprocating frame of claim 1, wherein the first composite blade has an angle between approximately 1 and less than 90 degrees.

12. The reciprocating frame of claim 1, wherein the first composite blade has an angle between approximately 1 and 45 degrees.

13. A method of manufacturing a composite blade for a reciprocating frame, the method comprising:
forming an angle base to define a pocket;
filling the pocket with a filler material; and
machining the angle base and the filler material into a composite beveled cutting surface for a reciprocating frame.

14. The method according to claim 13, wherein forming the angle base to define a pocket includes bending the angle base.

15. The method according to claim 13, wherein forming the angle base into a pocket includes attaching two plates together.

16. The method according to claim 13, wherein the angle base comprises carbon steel.

17. The method according to claim 13, wherein the filler material has a coefficient of friction lower than carbon steel.

18. In a reciprocating frame having a rim, at least one support extending across an interior of the rim, and a first composite blade located on the rim, characterized in that the first composite blade includes a filler material.

19. The reciprocating frame of claim 18, characterized by the first composite blade having an angle base with a vertical leg and horizontal leg defining a pocket, and a filler material filling the pocket, wherein the angle base and the filler material share a composite beveled cutting surface.

20. The reciprocating frame of claim 18, further characterized by a second composite blade located on the support, the second composite blade including a filler material.
